(19) United States
(12) Patent Application Publication
(10) Pub. No.: US 2023/0058096 A1
(43) Pub. Date: Feb. 23, 2023

(54) METHOD AND SYSTEM FOR DENOISING USING NEURAL NETWORKS

(71) Applicant: GoPro, Inc., San Mateo, CA (US)

(72) Inventors: Matias Tassano Ferrés, Paris (FR); Nicolas Rahmouni, Paris (FR); Eva Coupeté, Paris (FR); Thomas Armel Derbanne, Paris (FR)

(21) Appl. No.: 17/678,438

(22) Filed: Feb. 23, 2022

Related U.S. Application Data
(60) Provisional application No. 63/234,883, filed on Aug. 19, 2021.

(51) Int. Cl. G06T 5/00; G06T 7/40

(52) U.S. Cl. CPC G06T 5/002; G06T 7/40; G06T 2207/20081; G06T 2207/20084; G06T 2207/10024

(57) ABSTRACT

Methods and systems for denoising. A method for denoising includes receiving an image from an image sensor, denoising the image, in a non-linear domain by a denoiser, by applying a noise map to the image to obtain a denoised image. Training losses for the denoiser are processed in a linear domain. The method includes storing, displaying, or transmitting an output image based on the denoised image.

### CROSS REFERENCE TO RELATED APPLICATION

This application claims priority to U.S. Provisional Application Ser. No. 63/234,883, filed Aug. 19, 2021, which is incorporated herein by reference.

### TECHNICAL FIELD

This disclosure relates to image denoising.

### BACKGROUND

Typical image denoising methods based on deep learning techniques require large computing times and have a large memory footprint and are impractical for deploying in an image capture device.

### SUMMARY

Disclosed herein are implementations of methods and systems for denoising images using neural networks.

An aspect may include a method for denoising. The method including receiving an image from an image sensor, denoising the image, in a non-linear domain by a denoiser, by applying a noise map to the image to obtain a denoised image, wherein training losses for the denoiser are processed in a linear domain, and storing, displaying, or transmitting an output image based on the denoised image. The method may further include applying a re-noising factor to the image to obtain the denoised image. The method may include texture map processing being accounted for during denoiser training. The method may include processing, in the non-linear domain by the denoiser in an offline configuration, a noisy image from a training dataset, comparing, in a linear domain, a training denoised image with a reference image, and optimizing the denoiser based on the comparison of the training denoised image with the reference image. The method may include the noise map being factored with a unity value. The method may include determining a loss between the training denoised image and the reference image, wherein the loss accounts for a texture map. The method may include setting a factor for a texture map which provides a greater weight to one of flat or texture in the noisy image and determining a texture map based loss between the training denoised image and the reference image.

An aspect may include a method for denoising. The method includes denoising an image, in a first color space by a denoiser, by applying a re-noising factor to the image to obtain a denoised image, wherein training losses for the denoiser are processed in a second color space, and storing, displaying, or transmitting an output image based on the denoised image. The method may include applying a noise map to the image to obtain the denoised image. The method may include a texture map weighting being accounted for during denoiser training. The method may include processing, in the first color space by the denoiser in a training configuration, a noisy image from a training dataset, comparing, in a second color space, a training denoised image with a reference image, and optimizing the denoiser based on the comparison of the training denoised image with the reference image, where the re-noising factor is disabled during denoiser training. The method may include a noise map being applied during denoising is factored with a unity value during training. The method may include determining a loss between the training denoised image and the reference image, wherein the loss accounts for a texture map weighting. The method may include setting a factor for a texture map which provides a greater weight to one of flat or texture in the noisy image and determining a texture map-based loss between the training denoised image and the reference image. The method may include the first color space being YUV. The method may include the second color space being RGB.

Aspects may include an image capture device. The image capture device an image sensor configured to detect an image and an image processor configured to receive the image in a first color domain and comprising a denoiser configured to denoise the image to obtain a denoised image in the first color domain, where weights and training losses for the denoiser are processed in a second color domain during an offline configuration and the weights are saved to the image capture device and where the image processor is configured to store, display, or transmit an output image based on the denoised image. The denoiser may be further configured to apply a re-noising factor to the image to obtain the denoised image. The denoiser may be further configured to apply a noise map to the image to obtain the denoised image. The image capture device may have training losses account for a texture map weighting selection which emphasizes one of flat or texture in the image.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-B are isometric views of an example of an image capture device.

FIGS. 2A-B are isometric views of another example of an image capture device.

FIG. 2C is a top view of the image capture device of FIGS. 2A-B.

FIG. 2D is a partial cross-sectional view of the image capture device of FIG. 2C.

FIG. 3 is a block diagram of electronic components of an image capture device.

FIG. 4 is a functional block diagram of an example of an image processing pipeline.

FIG. 5 is a block diagram of an example of a convolutional neural network.

FIG. 6 is a block diagram of an example of a convolutional neural network image denoising architecture or system.

FIG. 7 is a flow diagram of the convolutional neural network image denoising architecture or system of FIG. 6.

FIG. 8 is a block diagram of an example of a training model for the convolutional neural network image denoising architecture or system of FIG. 6.

FIG. 9 is a block diagram of an example of training database generation for the convolutional neural network image denoising architecture or system of FIG. 6.

FIG. 10 is a block diagram of an example of training for the convolutional neural network image denoising architecture or system of FIG. 6.

FIG. 11 is a flowchart of an example of image denoising.

FIG. 12 is a flowchart of an example of image denoising training.

### DETAILED DESCRIPTION

The implementations disclosed herein employ deep learning approaches to image denoising. The deep learning approached described herein is a lightweight convolutional neural network (CNN) denoiser where a CNN algorithm has on the order of one million training parameters and a multi-scale architecture to reduce the number of computations. The CNN denoiser is thus deployable onboard an image capture device.

The denoiser implementations disclosed herein may include multiple tuning parameters which are based on light level environments associated with image detection and capture (noise map tuning), additive ratio between input image and denoised image (re-noising tuning), and image texture. Application of the multiple tuning parameters may be done during training of denoiser, after training of the denoiser, and combinations thereof. In implementations, tuning of the image texture parameter may be done during training of the denoiser. In implementations, the noise map tuning and the re-noising tuning may be done after training of the denoiser. A user can use the noise map tuning and the re-noising tuning to obtain or tune to a desired level of detail versus image smoothness.

The denoiser may be implemented at later stages of an image signal processing pipeline. This enables use of non-linear space formatted images as input to and output from the denoiser, where a non-linear space may be YUV. Training of the denoiser may, however, be performed in a linear space to optimize image quality, where a linear space is RGB. Weights, for example in a CNN denoiser, may be determined in the linear space. That is, the denoiser may use mixed color spaces to denoise and train the denoiser.

The implementations of this disclosure are described in detail with reference to the drawings, which are provided as examples so as to enable those skilled in the art to practice the technology. The figures and examples are not meant to limit the scope of the present disclosure to a single implementation or embodiment, and other implementations and embodiments are possible by way of interchange of, or combination with, some or all of the described or illustrated elements. Wherever convenient, the same reference numbers will be used throughout the drawings to refer to same or like parts.

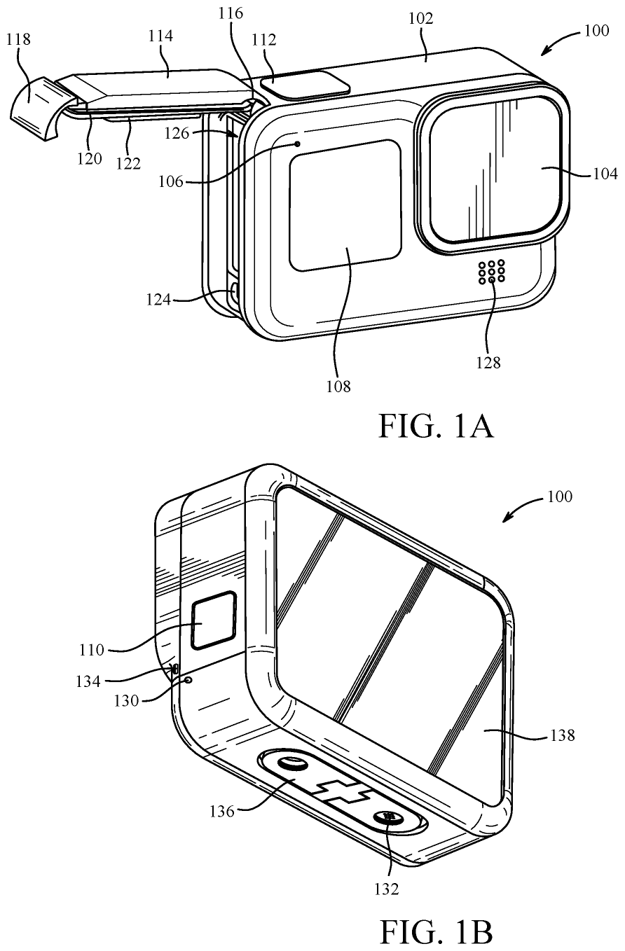

FIGS. 1A-B are isometric views of an example of an image capture device 100. The image capture device 100 may include a body 102, a lens 104 structured on a front surface of the body 102, various indicators on the front surface of the body 102 (such as light-emitting diodes (LEDs), displays, and the like), various input mechanisms (such as buttons, switches, and/or touch-screens), and electronics (such as imaging electronics, power electronics, etc.) internal to the body 102 for capturing images via the lens 104 and/or performing other functions. The lens 104 is configured to receive light incident upon the lens 104 and to direct received light onto an image sensor internal to the body 102. The image capture device 100 may be configured to capture images and video and to store captured images and video for subsequent display or playback.

The image capture device 100 may include an LED or another form of indicator 106 to indicate a status of the image capture device 100 and a liquid-crystal display (LCD) or other form of a display 108 to show status information such as battery life, camera mode, elapsed time, and the like. The image capture device 100 may also include a mode button 110 and a shutter button 112 that are configured to allow a user of the image capture device 100 to interact with the image capture device 100. For example, the mode button 110 and the shutter button 112 may be used to turn the image capture device 100 on and off, scroll through modes and settings, and select modes and change settings. The image capture device 100 may include additional buttons or interfaces (not shown) to support and/or control additional functionality.

The image capture device 100 may include a door 114 coupled to the body 102, for example, using a hinge mechanism 116. The door 114 may be secured to the body 102 using a latch mechanism 118 that releasably engages the body 102 at a position generally opposite the hinge mechanism 116. The door 114 may also include a seal 120 and a battery interface 122. When the door 114 is an open position, access is provided to an input-output (I/O) interface 124 for connecting to or communicating with external devices as described below and to a battery receptacle 126 for placement and replacement of a battery (not shown). The battery receptacle 126 includes operative connections (not shown) for power transfer between the battery and the image capture device 100. When the door 114 is in a closed position, the seal 120 engages a flange (not shown) or other interface to provide an environmental seal, and the battery interface 122 engages the battery to secure the battery in the battery receptacle 126. The door 114 can also have a removed position (not shown) where the entire door 114 is separated from the image capture device 100, that is, where both the hinge mechanism 116 and the latch mechanism 118 are decoupled from the body 102 to allow the door 114 to be removed from the image capture device 100.

The image capture device 100 may include a microphone 128 on a front surface and another microphone 130 on a side surface. The image capture device 100 may include other microphones on other surfaces (not shown). The microphones 128, 130 may be configured to receive and record audio signals in conjunction with recording video or separate from recording of video. The image capture device 100 may include a speaker 132 on a bottom surface of the image capture device 100. The image capture device 100 may include other speakers on other surfaces (not shown). The speaker 132 may be configured to play back recorded audio or emit sounds associated with notifications.

A front surface of the image capture device 100 may include a drainage channel 134. A bottom surface of the image capture device 100 may include an interconnect mechanism 136 for connecting the image capture device 100 to a handle grip or other securing device. In the example shown in FIG. 1B, the interconnect mechanism 136 includes folding protrusions configured to move between a nested or collapsed position as shown and an extended or open position (not shown) that facilitates coupling of the protrusions to mating protrusions of other devices such as handle grips, mounts, clips, or like devices.

The image capture device 100 may include an interactive display 138 that allows for interaction with the image capture device 100 while simultaneously displaying information on a surface of the image capture device 100.

The image capture device 100 of FIGS. 1A-B includes an exterior that encompasses and protects internal electronics. In the present example, the exterior includes six surfaces (i.e. a front face, a left face, a right face, a back face, a top face, and a bottom face) that form a rectangular cuboid. Furthermore, both the front and rear surfaces of the image capture device 100 are rectangular. In other embodiments, the exterior may have a different shape. The image capture device 100 may be made of a rigid material such as plastic, aluminum, steel, or fiberglass. The image capture device 100 may include features other than those described here. For example, the image capture device 100 may include additional buttons or different interface features, such as interchangeable lenses, cold shoes, and hot shoes that can add functional features to the image capture device 100.

The image capture device 100 may include various types of image sensors, such as charge-coupled device (CCD) sensors, active pixel sensors (APS), complementary metal-oxide-semiconductor (CMOS) sensors, N-type metal-oxide-semiconductor (NMOS) sensors, and/or any other image sensor or combination of image sensors.

Although not illustrated, in various embodiments, the image capture device 100 may include other additional electrical components (e.g., an image processor, camera system-on-chip (SoC), etc.), which may be included on one or more circuit boards within the body 102 of the image capture device 100.

The image capture device 100 may interface with or communicate with an external device, such as an external user interface device (not shown), via a wired or wireless computing communication link (e.g., the I/O interface 124). Any number of computing communication links may be used. The computing communication link may be a direct computing communication link or an indirect computing communication link, such as a link including another device or a network, such as the internet, may be used.

In some implementations, the computing communication link may be a Wi-Fi link, an infrared link, a Bluetooth (BT) link, a cellular link, a ZigBee link, a near field communications (NFC) link, such as an ISO/IEC 20643 protocol link, an Advanced Network Technology interoperability (ANT+) link, and/or any other wireless communications link or combination of links.

In some implementations, the computing communication link may be an HDMI link, a USB link, a digital video interface link, a display port interface link, such as a Video Electronics Standards Association (VESA) digital display interface link, an Ethernet link, a Thunderbolt link, and/or other wired computing communication link.

The image capture device 100 may transmit images, such as panoramic images, or portions thereof, to the external user interface device via the computing communication link, and the external user interface device may store, process, display, or a combination thereof the panoramic images.

The external user interface device may be a computing device, such as a smartphone, a tablet computer, a phablet, a smart watch, a portable computer, personal computing device, and/or another device or combination of devices configured to receive user input, communicate information with the image capture device 100 via the computing communication link, or receive user input and communicate information with the image capture device 100 via the computing communication link.

The external user interface device may display, or otherwise present, content, such as images or video, acquired by the image capture device 100. For example, a display of the external user interface device may be a viewport into the three-dimensional space represented by the panoramic images or video captured or created by the image capture device 100.

The external user interface device may communicate information, such as metadata, to the image capture device 100. For example, the external user interface device may send orientation information of the external user interface device with respect to a defined coordinate system to the image capture device 100, such that the image capture device 100 may determine an orientation of the external user interface device relative to the image capture device 100.

Based on the determined orientation, the image capture device 100 may identify a portion of the panoramic images or video captured by the image capture device 100 for the image capture device 100 to send to the external user interface device for presentation as the viewport. In some implementations, based on the determined orientation, the image capture device 100 may determine the location of the external user interface device and/or the dimensions for viewing of a portion of the panoramic images or video.

The external user interface device may implement or execute one or more applications to manage or control the image capture device 100. For example, the external user interface device may include an application for controlling camera configuration, video acquisition, video display, or any other configurable or controllable aspect of the image capture device 100.

The user interface device, such as via an application, may generate and share, such as via a cloud-based or social media service, one or more images, or short video clips, such as in response to user input. In some implementations, the external user interface device, such as via an application, may remotely control the image capture device 100 such as in response to user input.

The external user interface device, such as via an application, may display unprocessed or minimally processed images or video captured by the image capture device 100 contemporaneously with capturing the images or video by the image capture device 100, such as for shot framing or live preview, and which may be performed in response to user input. In some implementations, the external user interface device, such as via an application, may mark one or more key moments contemporaneously with capturing the images or video by the image capture device 100, such as with a tag or highlight in response to a user input or user gesture.

The external user interface device, such as via an application, may display or otherwise present marks or tags associated with images or video, such as in response to user input. For example, marks may be presented in a camera roll application for location review and/or playback of video highlights.

The external user interface device, such as via an application, may wirelessly control camera software, hardware, or both. For example, the external user interface device may include a web-based graphical interface accessible by a user for selecting a live or previously recorded video stream from the image capture device 100 for display on the external user interface device.

The external user interface device may receive information indicating a user setting, such as an image resolution setting (e.g., 3840 pixels by 2160 pixels), a frame rate setting (e.g., 60 frames per second (fps)), a location setting, and/or a context setting, which may indicate an activity, such as mountain biking, in response to user input, and may communicate the settings, or related information, to the image capture device 100.

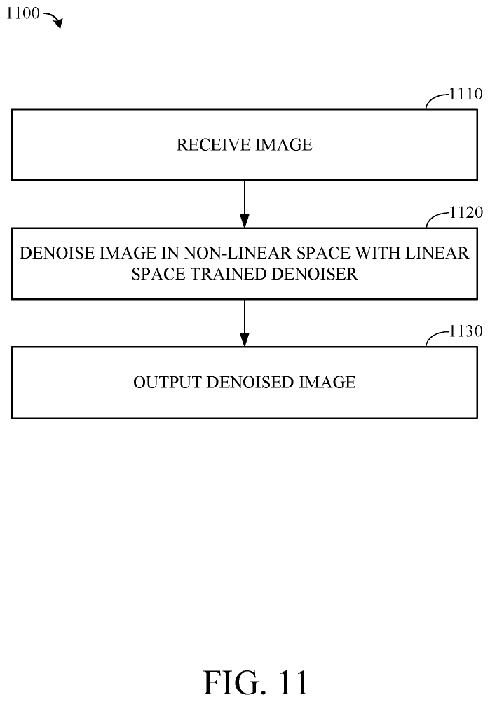

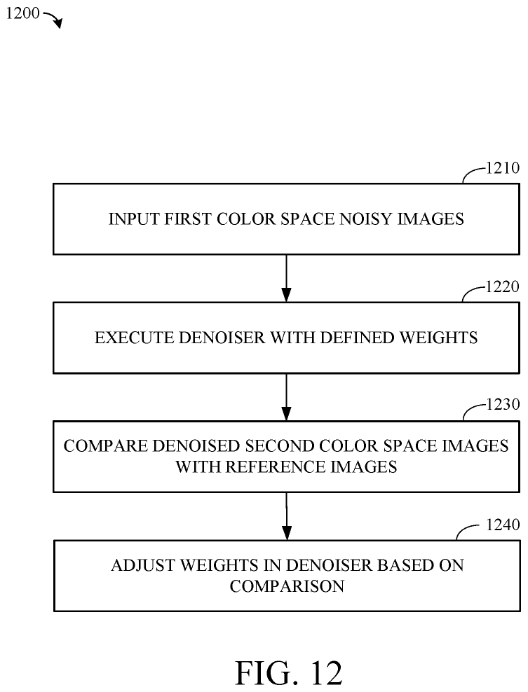

The image capture device 100 may be used to implement some or all of the techniques described in this disclosure, such as the technique 1100 described in FIG. 11, the technique 1200 described in FIG. 12, or combinations thereof.

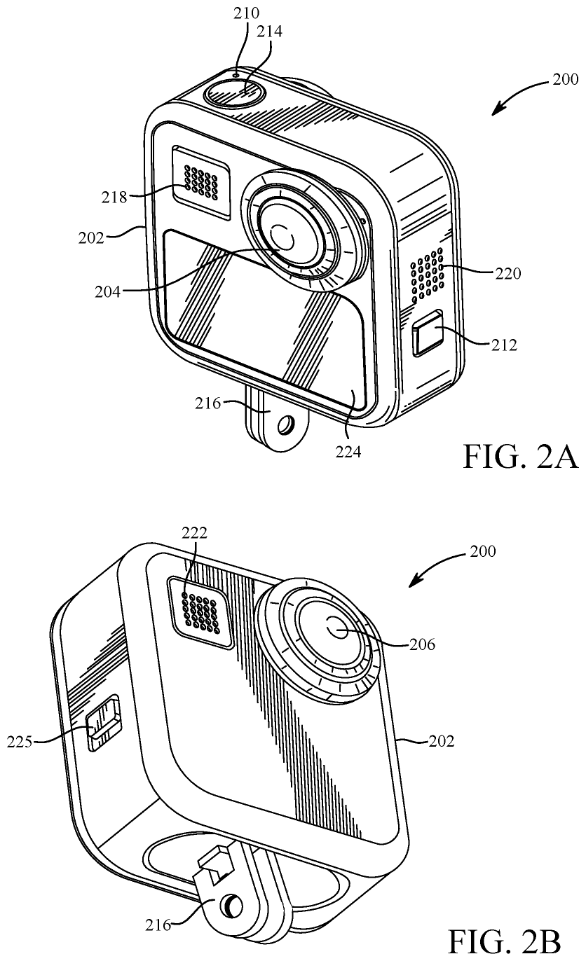

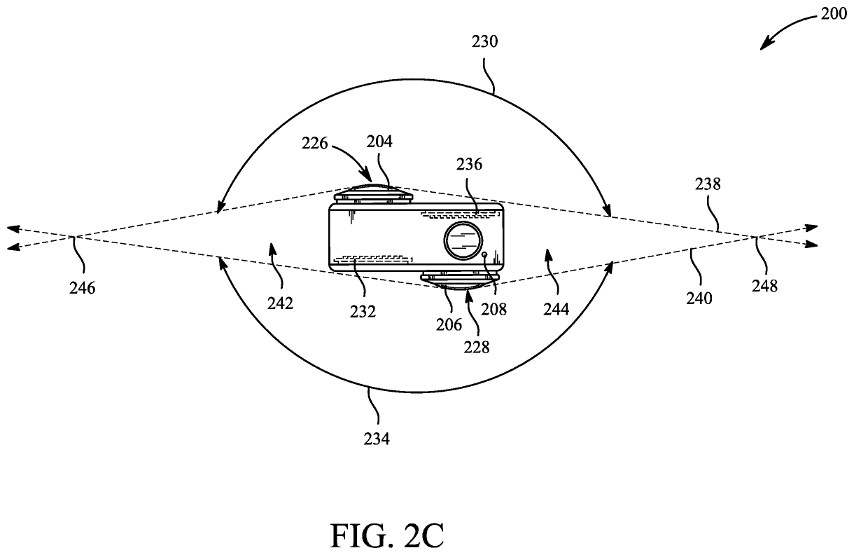

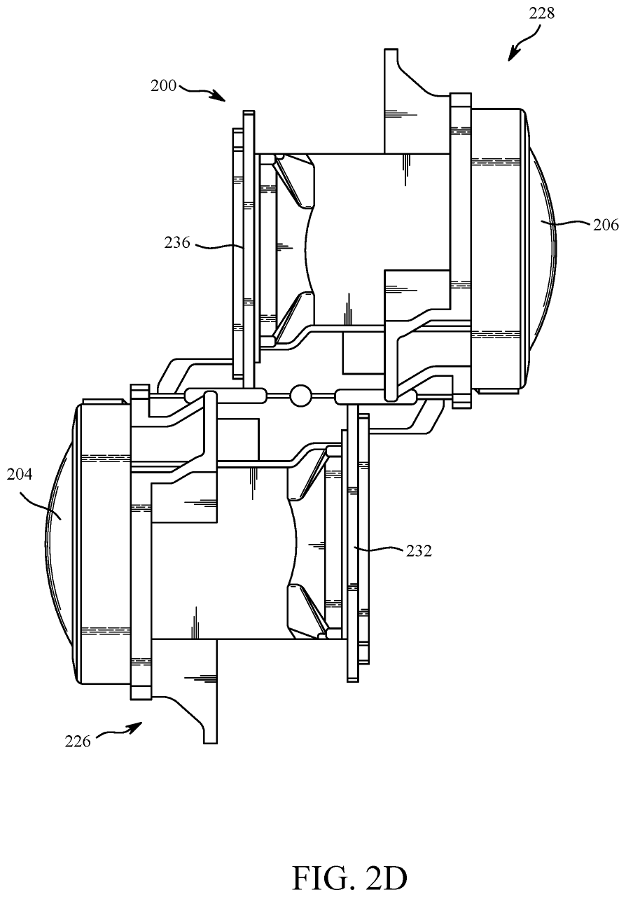

FIGS. 2A-B illustrate another example of an image capture device 200. The image capture device 200 includes a body 202 and two camera lenses 204 and 206 disposed on opposing surfaces of the body 202, for example, in a back-to-back configuration, Janus configuration, or offset Janus configuration. The body 202 of the image capture device 200 may be made of a rigid material such as plastic, aluminum, steel, or fiberglass.

The image capture device 200 includes various indicators on the front of the surface of the body 202 (such as LEDs, displays, and the like), various input mechanisms (such as buttons, switches, and touch-screen mechanisms), and electronics (e.g., imaging electronics, power electronics, etc.) internal to the body 202 that are configured to support image capture via the two camera lenses 204 and 206 and/or perform other imaging functions.

The image capture device 200 includes various indicators, for example, LEDs 208, 210 to indicate a status of the image capture device 100. The image capture device 200 may include a mode button 212 and a shutter button 214 configured to allow a user of the image capture device 200 to interact with the image capture device 200, to turn the image capture device 200 on, and to otherwise configure the operating mode of the image capture device 200. It should be appreciated, however, that, in alternate embodiments, the image capture device 200 may include additional buttons or inputs to support and/or control additional functionality.

The image capture device 200 may include an interconnect mechanism 216 for connecting the image capture device 200 to a handle grip or other securing device. In the example shown in FIGS. 2A and 2B, the interconnect mechanism 216 includes folding protrusions configured to move between a nested or collapsed position (not shown) and an extended or open position as shown that facilitates coupling of the protrusions to mating protrusions of other devices such as handle grips, mounts, clips, or like devices.

The image capture device 200 may include audio components 218, 220, 222 such as microphones configured to receive and record audio signals (e.g., voice or other audio commands) in conjunction with recording video. The audio component 218, 220, 222 can also be configured to play back audio signals or provide notifications or alerts, for example, using speakers. Placement of the audio components 218, 220, 222 may be on one or more of several surfaces of the image capture device 200. In the example of FIGS. 2A and 2B, the image capture device 200 includes three audio components 218, 220, 222, with the audio component 218 on a front surface, the audio component 220 on a side surface, and the audio component 222 on a back surface of the image capture device 200. Other numbers and configurations for the audio components are also possible.

The image capture device 200 may include an interactive display 224 that allows for interaction with the image capture device 200 while simultaneously displaying information on a surface of the image capture device 200. The interactive display 224 may include an I/O interface, receive touch inputs, display image information during video capture, and/or provide status information to a user. The status information provided by the interactive display 224 may include battery power level, memory card capacity, time elapsed for a recorded video, etc.

The image capture device 200 may include a release mechanism 225 that receives a user input to in order to change a position of a door (not shown) of the image capture device 200. The release mechanism 225 may be used to open the door (not shown) in order to access a battery, a battery receptacle, an I/O interface, a memory card interface, etc. (not shown) that are similar to components described in respect to the image capture device 100 of FIGS. 1A and 1B.

In some embodiments, the image capture device 200 described herein includes features other than those described. For example, instead of the I/O interface and the interactive display 224, the image capture device 200 may include additional interfaces or different interface features. For example, the image capture device 200 may include additional buttons or different interface features, such as interchangeable lenses, cold shoes, and hot shoes that can add functional features to the image capture device 200.

FIG. 2C is a top view of the image capture device 200 of FIGS. 2A-B and FIG. 2D is a partial cross-sectional view of the image capture device 200 of FIG. 2C. The image capture device 200 is configured to capture spherical images, and accordingly, includes a first image capture device 226 and a second image capture device 228. The first image capture device 226 defines a first field-of-view 230 and includes the lens 204 that receives and directs light onto a first image sensor 232. Similarly, the second image capture device 228 defines a second field-of-view 234 and includes the lens 206 that receives and directs light onto a second image sensor 236. To facilitate the capture of spherical images, the image capture devices 226 and 228 (and related components) may be arranged in a back-to-back (Janus) configuration such that the lenses 204, 206 face in generally opposite directions.

The fields-of-view 230, 234 of the lenses 204, 206 are shown above and below boundaries 238, 240 indicated in dotted line. Behind the first lens 204, the first image sensor 232 may capture a first hyper-hemispherical image plane from light entering the first lens 204, and behind the second lens 206, the second image sensor 236 may capture a second hyper-hemispherical image plane from light entering the second lens 206.

One or more areas, such as blind spots 242, 244 may be outside of the fields-of-view 230, 234 of the lenses 204, 206 so as to define a “dead zone.” In the dead zone, light may be obscured from the lenses 204, 206 and the corresponding image sensors 232, 236, and content in the blind spots 242, 244 may be omitted from capture. In some implementations, the image capture devices 226, 228 may be configured to minimize the blind spots 242, 244.

The fields-of-view 230, 234 may overlap. Stitch points 246, 248 proximal to the image capture device 200, that is, locations at which the fields-of-view 230, 234 overlap, may be referred to herein as overlap points or stitch points. Content captured by the respective lenses 204, 206 that is distal to the stitch points 246, 248 may overlap.

Images contemporaneously captured by the respective image sensors 232, 236 may be combined to form a combined image. Generating a combined image may include correlating the overlapping regions captured by the respective image sensors 232, 236, aligning the captured fields-of-view 230, 234, and stitching the images together to form a cohesive combined image.

A slight change in the alignment, such as position and/or tilt, of the lenses 204, 206, the image sensors 232, 236, or both, may change the relative positions of their respective fields-of-view 230, 234 and the locations of the stitch points 246, 248. A change in alignment may affect the size of the blind spots 242, 244, which may include changing the size of the blind spots 242, 244 unequally.

Incomplete or inaccurate information indicating the alignment of the image capture devices 226, 228, such as the locations of the stitch points 246, 248, may decrease the accuracy, efficiency, or both of generating a combined image. In some implementations, the image capture device 200 may maintain information indicating the location and orientation of the lenses 204, 206 and the image sensors 232, 236 such that the fields-of-view 230, 234, the stitch points 246, 248, or both may be accurately determined; the maintained information may improve the accuracy, efficiency, or both of generating a combined image.

The lenses 204, 206 may be laterally offset from each other, may be off-center from a central axis of the image capture device 200, or may be laterally offset and off-center from the central axis. As compared to image capture devices with back-to-back lenses, such as lenses aligned along the same axis, image capture devices including laterally offset lenses may include substantially reduced thickness relative to the lengths of the lens barrels securing the lenses. For example, the overall thickness of the image capture device 200 may be close to the length of a single lens barrel as opposed to twice the length of a single lens barrel as in a back-to-back lens configuration. Reducing the lateral distance between the lenses 204, 206 may improve the overlap in the fields-of-view 230, 234. In another embodiment (not shown), the lenses 204, 206 may be aligned along a common imaging axis.

Images or frames captured by the image capture devices 226, 228 may be combined, merged, or stitched together to produce a combined image, such as a spherical or panoramic image, which may be an equirectangular planar image. In some implementations, generating a combined image may include use of techniques including noise reduction, tone mapping, white balancing, or other image correction. In some implementations, pixels along the stitch boundary may be matched accurately to minimize boundary discontinuities.

The image capture device 200 may be used to implement some or all of the techniques described in this disclosure, such as the technique 1100 described in FIG. 11, the technique 1200 described in FIG. 12, or combinations thereof.

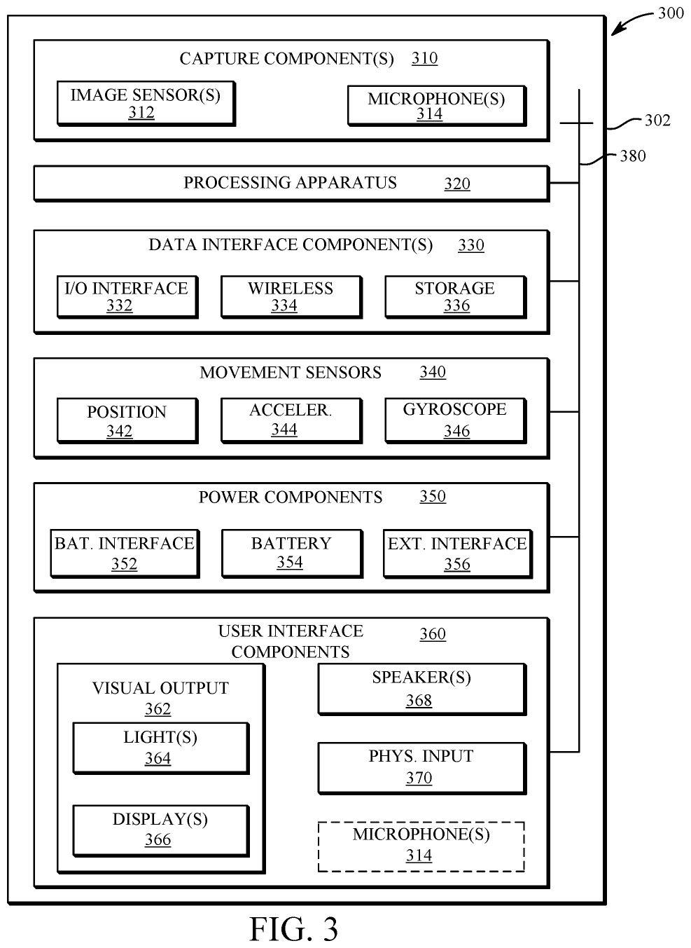

FIG. 3 is a block diagram of electronic components in an image capture device 300. The image capture device 300 may be a single-lens image capture device, a multi-lens image capture device, or variations thereof, including an image capture device with multiple capabilities such as use of interchangeable integrated sensor lens assemblies. The description of the image capture device 300 is also applicable to the image capture devices 100, 200 of FIGS. 1A-B and 2A-D.

The image capture device 300 includes a body 302 which includes electronic components such as capture components 310, a processing apparatus 320, data interface components 330, movement sensors 340, power components 350, and/or user interface components 360.

The capture components 310 include one or more image sensors 312 for capturing images and one or more microphones 314 for capturing audio.

The image sensor(s) 312 is configured to detect light of a certain spectrum (e.g., the visible spectrum or the infrared spectrum) and convey information constituting an image as electrical signals (e.g., analog or digital signals). The image sensor(s) 312 detects light incident through a lens coupled or connected to the body 302. The image sensor(s) 312 may be any suitable type of image sensor, such as a charge-coupled device (CCD) sensor, active pixel sensor (APS), complementary metal-oxide-semiconductor (CMOS) sensor, N-type metal-oxide-semiconductor (NMOS) sensor, and/or any other image sensor or combination of image sensors. Image signals from the image sensor(s) 312 may be passed to other electronic components of the image capture device 300 via a bus 380, such as to the processing apparatus 320. In some implementations, the image sensor(s) 312 includes a digital-to-analog converter. A multi-lens variation of the image capture device 300 can include multiple image sensors 312.

The microphone(s) 314 is configured to detect sound, which may be recorded in conjunction with capturing images to form a video. The microphone(s) 314 may also detect sound in order to receive audible commands to control the image capture device 300.

The processing apparatus 320 may be configured to perform image signal processing (e.g., filtering, tone mapping, stitching, and/or encoding) to generate output images based on image data from the image sensor(s) 312. The processing apparatus 320 may include one or more processors having single or multiple processing cores. In some implementations, the processing apparatus 320 may include an application specific integrated circuit (ASIC). For example, the processing apparatus 320 may include a custom image signal processor. The processing apparatus 320 may exchange data (e.g., image data) with other components of the image capture device 300, such as the image sensor(s) 312, via the bus 380.

The processing apparatus 320 may include memory, such as a random-access memory (RAM) device, flash memory, or another suitable type of storage device, such as a non-transitory computer-readable memory. The memory of the processing apparatus 320 may include executable instructions and data that can be accessed by one or more processors of the processing apparatus 320. For example, the processing apparatus 320 may include one or more dynamic random-access memory (DRAM) modules, such as double data rate synchronous dynamic random-access memory (DDR SDRAM). In some implementations, the processing apparatus 320 may include a digital signal processor (DSP). More than one processing apparatus may also be present or associated with the image capture device 300.

The data interface components 330 enable communication between the image capture device 300 and other electronic devices, such as a remote control, a smartphone, a tablet computer, a laptop computer, a desktop computer, or a storage device. For example, the data interface components 330 may be used to receive commands to operate the image capture device 300, transfer image data to other electronic devices, and/or transfer other signals or information to and from the image capture device 300. The data interface components 330 may be configured for wired and/or wireless communication. For example, the data interface components 330 may include an I/O interface 332 that provides wired communication for the image capture device, which may be a USB interface (e.g., USB type-C), a high-definition multimedia interface (HDMI), or a FireWire interface. The data interface components 330 may include a wireless data interface 334 that provides wireless communication for the image capture device 300, such as a Bluetooth interface, a ZigBee interface, and/or a Wi-Fi interface. The data interface components 330 may include a storage interface 336, such as a memory card slot configured to receive and operatively couple to a storage device (e.g., a memory card) for data transfer with the image capture device 300 (e.g., for storing captured images and/or recorded audio and video).

The movement sensors 340 may detect the position and movement of the image capture device 300. The movement sensors 340 may include a position sensor 342, an accelerometer 344, or a gyroscope 346. The position sensor 342, such as a global positioning system (GPS) sensor, is used to determine a position of the image capture device 300. The accelerometer 344, such as a three-axis accelerometer, measures linear motion (e.g., linear acceleration) of the image capture device 300. The gyroscope 346, such as a three-axis gyroscope, measures rotational motion (e.g., rate of rotation) of the image capture device 300. Other types of movement sensors 340 may also be present or associated with the image capture device 300.

The power components 350 may receive, store, and/or provide power for operating the image capture device 300. The power components 350 may include a battery interface 352 and a battery 354. The battery interface 352 operatively couples to the battery 354, for example, with conductive contacts to transfer power from the battery 354 to the other electronic components of the image capture device 300. The power components 350 may also include an external interface 356, and the power components 350 may, via the external interface 356, receive power from an external source, such as a wall plug or external battery, for operating the image capture device 300 and/or charging the battery 354 of the image capture device 300. In some implementations, the external interface 356 may be the I/O interface 332. In such an implementation, the I/O interface 332 may enable the power components 350 to receive power from an external source over a wired data interface component (e.g., a USB type-C cable).

The user interface components 360 may allow the user to interact with the image capture device 300, for example, providing outputs to the user and receiving inputs from the user. The user interface components 360 may include visual output components 362 to visually communicate information and/or present captured images to the user. The visual output components 362 may include one or more lights 364 and/or more displays 366. The display(s) 366 may be configured as a touch screen that receives inputs from the user. The user interface components 360 may also include one or more speakers 368. The speaker(s) 368 can function as an audio output component that audibly communicates information and/or presents recorded audio to the user. The user interface components 360 may also include one or more physical input interfaces 370 that are physically manipulated by the user to provide input to the image capture device 300. The physical input interfaces 370 may, for example, be configured as buttons, toggles, or switches. The user interface components 360 may also be considered to include the microphone(s) 314, as indicated in dotted line, and the microphone(s) 314 may function to receive audio inputs from the user, such as voice commands.

The image capture device 300 may be used to implement some or all of the techniques described in this disclosure, such as the technique 1100 described in FIG. 11, the technique 1200 described in FIG. 12, or combinations thereof.

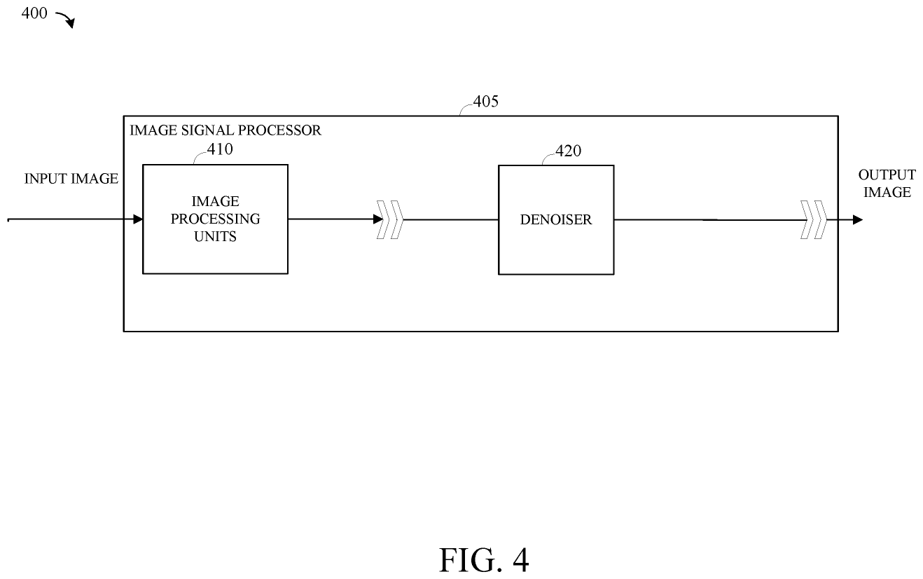

FIG. 4 is a block diagram of an example of an image processing pipeline 400 in accordance with implementations of this disclosure. In some implementations, the image processing pipeline 400 may be included in an image capture device, such as the image capture device 100 shown in FIGS. 1A-1B, the image capture device 200 shown in FIGS. 2A-2D, the image capture device 300 shown in FIG. 3, or combinations thereof. In some implementations, the image processing pipeline 400 may be included in a separate device configured to receive the input images. In some implementations, the image processing 400 may include an image signal processor (ISP) 405.

The image signal processor 405 may receive an input image signal and output an output image. For example, an image sensor (not shown), such as first image sensor 232 or second image sensor 236 shown in FIG. 2C, may capture an image, or a portion thereof, and may send, or transmit, the captured image, or image portion, to the image signal processor 405 as the input image signal. In some implementations, an image, or frame, such as an image, or frame, included in the input image signal, may be one of a sequence or series of images or frames of a video, such as a sequence, or series, of frames captured at a rate, or frame rate, which may be a number or cardinality of frames captured per defined temporal period, such as twenty-four, thirty, or sixty frames per second.

The image signal processor 405 may include image processing units 410, which may include dynamic range enhancement, image stitching, scaling, color balancing, clipping, tone mapping, and other image processing to the input image.

The image signal processor 405 may include a denoiser 420, which may restore noise from the input image, denoise noise from the input image, and combinations thereof. In implementations, the denoiser 420 may use deep learning techniques. In implementations, the denoiser 420 may use a neural network based algorithm. In implementations, the denoiser 420 may use a CNN algorithm. In implementations, the denoiser 420 may be performed in the non-linear domain or a first color space. For example, the denoiser 420 may apply the processing to the input image in a non-linear color space. The non-linear color space, for example, may be the YUV color space. In implementations, the denoiser 420 may be trained in the linear domain or a second color space. For example, CNN weights and certain tuning factors can be determined in a linear color space. The linear color space, for example, may be the RGB color space.

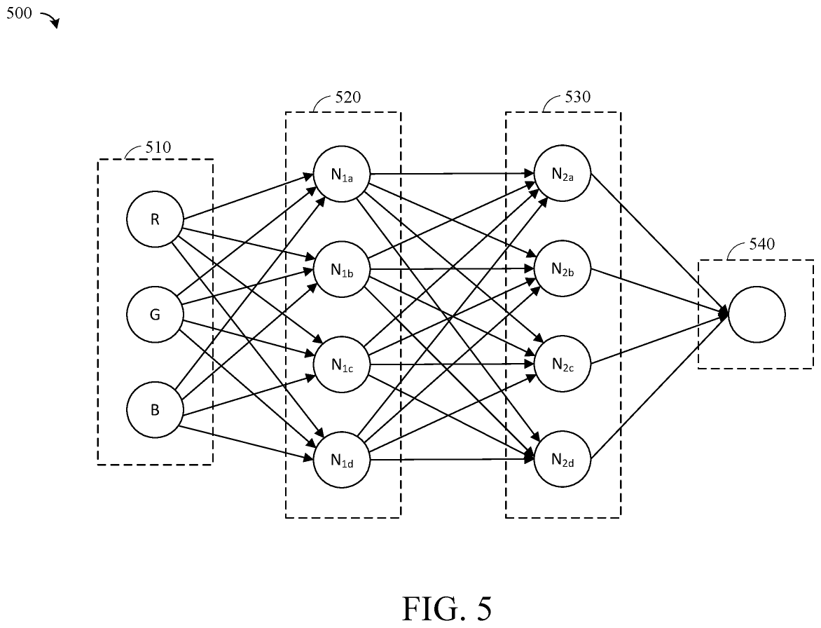

FIG. 5 is a block diagram of an example of a CNN 500 in accordance with embodiments of this disclosure. As shown in FIG. 5, the convolutional neural network 500 includes an input layer 510, a first hidden layer 520, a second hidden layer 530, and an output layer 540. The example CNN 500 may include any number of hidden layers, and two hidden layers are shown merely as an example for simplicity and clarity. The input layer 510 may hold the raw pixel values of an image arranged in three dimensions. The three dimensions may include a width, a height, and a depth. The depth may refer to an activation volume. The input images are an input volume of activations, and the volume has dimensions of width, height, and depth. For example, the input layer 510 may include raw pixel values associated with an image width in pixels, an image height in pixels, and with three channels, luminance (Y) and two chrominance (U) and (V).

The first hidden layer 520 and the second hidden layer 530 each include a set of neurons, where each neuron is fully connected to all the neurons in the previous layer. For example, neuron N_{2b} of the second hidden layer 530 is connected to neuron N₁ₐ, neuron N_{1b}, neuron N_{1c}, and neuron N_{1d} of the first hidden layer 520. The neurons of the first hidden layer 520 and the second hidden layer 530 are arranged in three dimensions having a width, a height, and a depth. The depth refers to the third dimension of an activation volume, and may refer to the total number of layers in a network. In some embodiments, the neurons in a layer may only be connected to a small region of the layer before it, rather than in a fully-connected manner.

The first hidden layer 520 and the second hidden layer 530 each perform transformations that are a function of the activations and of the parameters (i.e., the weights and biases of the neurons). The first hidden layer 520 receives an input at each neuron from each channel of the input layer 510. Each neuron of the first hidden layer 520 transforms the input from each channel. The second hidden layer 530 receives the transformed input at each neuron from each neuron from the first hidden layer 520. Each neuron of the second hidden layer 530 transforms the transformed input from each neuron of the first hidden layer 520. In some examples, the first hidden layer 520, the second hidden layer 530, or both, may include a convolutional layer, a rectified linear unit (ReLU) activation layer, a normalization layer, or any combination thereof in any order. The convolutional layer may be configured to compute the output of neurons that are connected to local regions in the input, each neuron computing a dot product between their weights and a small region to which they are connected in the input volume. The ReLU activation layer may apply an elementwise activation function, for example, the max(x, 0) thresholding at zero. The normalization layer may be used to normalize the input layer by adjusting and scaling the output of the previous activation layer.

The output layer 540 may be referred to as a fully-connected layer. The output layer 540 is configured to perform transformations that are a function of the activations and of the parameters (i.e., the weights and biases of the neurons). The output layer 540 may be configured to compute a score, for example, a classification score to categorize an image.

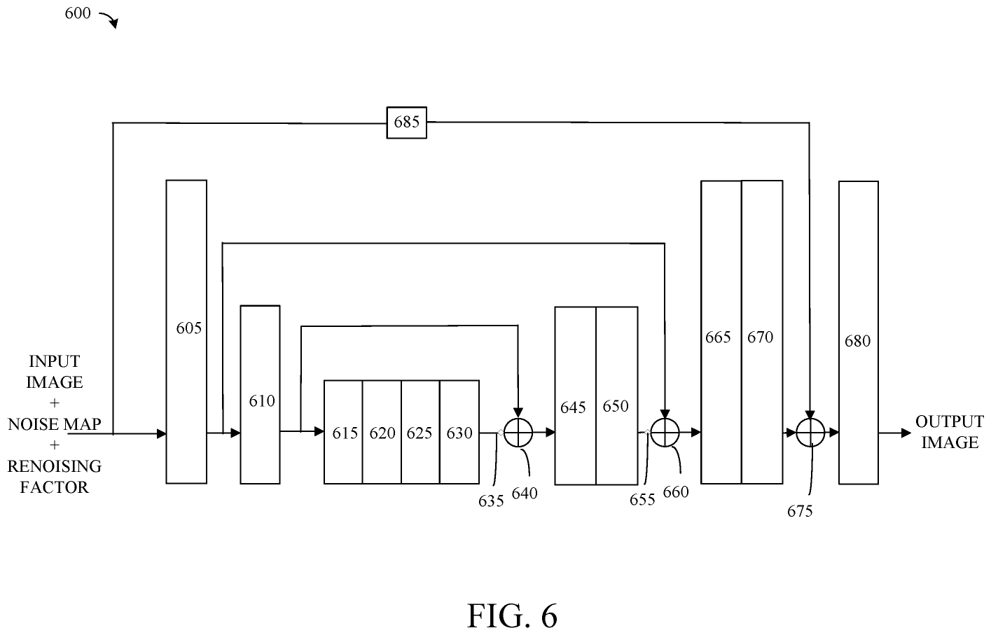

FIG. 6 is a block diagram of an example of a CNN image denoising model, algorithm, or architecture 600. In implementations, the denoiser 420 may be implemented using the CNN image denoising architecture or algorithm 600. The CNN algorithm 600 may have three inputs including an input image, a noise map, and a re-noising factor. The CNN architecture 600 may include a convolutional with ReLU layer 605, which has a stride of two, a convolutional with ReLU layer 610, a convolutional with ReLU layer 615, which has a stride of two, a convolutional with ReLU layer 620, a convolutional with ReLU layer 625, a convolutional layer 630, a depth-to-space conversion unit 635, an adder 640, a convolutional with ReLU layer 645, a convolutional layer 650, a depth-to-space conversion unit 655, an adder 660, a convolutional with ReLU layer 665, a convolutional layer 670, an adder 675, and a linear space to non-linear space converter 680.

The convolutional with ReLU layer 605 may have a stride of two and operate at a full resolution. After a downscaling operation, an output of the convolutional with ReLU layer 605 may be connected to an input of the convolutional with ReLU layer 610, which may operate at a half resolution. After a downscaling operation, an output of the convolutional with ReLU layer 610 may be connected to the convolutional with ReLU layer 615, which may operate at a quarter resolution. The output of the convolutional with ReLU layer 615 may be connected to the convolutional with ReLU layer 620. The output of the convolutional with ReLU layer 620 may be connected to the convolutional with ReLU layer 625. The output of the convolutional with ReLU layer 625 may be connected to the convolutional layer 630. The output of the convolutional layer 630 may be connected to the depth-to-space conversion unit 635, which in turn is connected to the adder 640. The output of the convolutional with ReLU layer 610 may have a residual connection to the adder 640. After an upscaling operation, the output of the adder is connected to the convolutional with ReLU layer 645, which in turn may be connected to the convolutional layer 650. Both of which may operate at a half resolution. The output of the convolutional layer 650 may be connected to the depth-to-space conversion unit 655, which in turn may be connected to the adder 660. The output of the convolutional with ReLU layer 605 may have a residual connection to the adder 660. After an upscaling operation, the output of the adder 660 may be connected to the convolutional with ReLU layer 665, which in turn may be connected to the convolutional layer 670. Both of which may operate at a full resolution. The output of the convolutional layer 670 may be connected to the adder 675. The re-noising factor 685 may be an input to the adder 675. The output of the adder 675 may be connected to the linear space to non-linear space converter 680. The CNN architecture 600 may output a non-linear denoised image. As shown, the multi-scaling architecture can reduce the number of computations, enabling deployment of the CNN algorithm 600 on an image capture device.

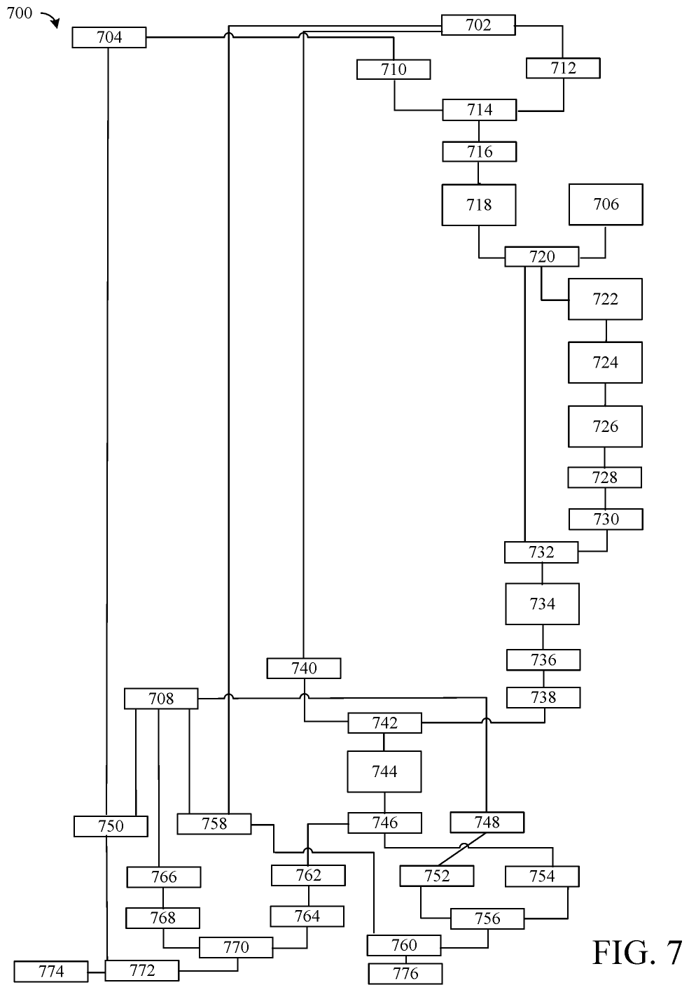

FIG. 7 is an example flow diagram 700 which follows from the CNN algorithm or architecture 600 of FIG. 6. As noted, input images may be input to the CNN algorithm 600. In implementations, the input image may be a YUV formatted image. In implementations, the input image may be a YUV 4:2:2 formatted image, where a Y channel is at a full resolution (H×W×1) and the U and V channels are at a half resolution (H/2×W×1). Consequently, the CNN algorithm 600 may use two input buffers, a Y channel input buffer 702 and a UV input buffer 704. The UV channel inputs may undergo resize operations 710 and the Y channel inputs may undergo a depthwise 2D convolution 712. A concatenation operation 714 may be performed on the output of the resize operations 710 and the depthwise 2D convolution 712. The output of the concatenation operation 714 may be processed by a ReLU layer 716 and a 2D convolution and ReLU layer 718. A concatenation operation 720 may be performed on the output of the 2D convolution and ReLU layer 718 and the noise map 716.

The output of the concatenation operation 720 may be processed through a 2D convolution and ReLU layer 722, a 2D convolution and ReLU layer 724, a 2D convolution and ReLU layer 726, a 2D convolution layer 728, and a depth-to-space conversion unit 730. An add operation 732 adds the output of the depth-to-space conversion unit 730 with a residual output connection from the concatenation operation 720. The output of the add operation 732 may be processed through a 2D convolution and ReLU layer 734, a 2D convolution layer 736, and a depth-to-space conversion unit 738. A depthwise 2D convolution 740 may be performed on the Y channel inputs. An add operation 742 adds the output of the depth-to-space conversion unit 738 with the output of the depthwise 2D convolution 740. The output of the add operation 742 may be processed through a 2D convolution and ReLU layer 744 and a 2D convolution layer 746. A 2D convolution layer 754 may process the output of the 2D convolution layer 746.

The re-noising factor 708 is input to a multiply operation 748, a multiply operation 750, a multiply operation 758, and a multiply operation 766. An add operation 752 may operate on the output of the multiply operation 748 (a multiply by 1 operation followed by a zero add operation). A multiply operation 756 may multiply the output of the 2D convolution layer 746 and the add operation 752. An add operation 760 may add the output of the multiply operation 756 and the output of the multiply operation 758, which may multiply the re-noising factor 708 with the Y channel inputs. The output of the add operation 760 may be a Y channel output 776.

The output of the 2D convolution layer 746 may be processed through a 2D convolution layer 762 and a resize operation 764. The output of the multiply operation 766 may be processed through an add operation 768. A multiply operation 770 may multiply the output of the resize operation 764 and the add operation 768. The multiply operation 750 may multiply the UV channel inputs 704 with the re-noising factor 708. An add operation 772 may add the output of the multiply operation 750 and the multiply operation 770. The output of the add operation 772 may be UV channels output 774.

As noted, the CNN algorithm 600 may have as input parameters, the noise map and the re-noising factor. Both of these input parameters may be used after the CNN algorithm 600 is trained as described herein below.

In a trained state, the denoiser may use the noise map to control denoising processing based on light level conditions or ISO levels used by an image capture device at image detection and capture. Typically, image capture devices have a range of ISO values or settings that may be used depending on a light level in a to be captured scene. Higher ISO values may be used to detect and capture a brighter image when light levels are low in the to be captured scene. However, higher ISO values result in images with higher levels of grain or noise. That is, the noise map is an indication of how much noise there is in the image. The noise map parameter is a normalized ISO calculation multiplied by a noise map factor α_{NM} as follows:

$$noise map = {α}_{NM} [ \frac{{ISO}_{input} - {ISO}_{min}}{{ISO}_{max} - {ISO}_{min}} ]$$

The noise map is at a half resolution of the input resolution. The noise map value is the same for all pixels in the image. In implementations, the ISOₘᵢₙ may be 0 and the ISOₘₐₓ may be 3200. Other values may be used for the ISOₘᵢₙ and ISOₘₐₓ without departing from the scope of the claims or specification. The ISOᵢₙₚᵤₜ can be obtained from the settings in the image capture device. A user can increase the amount of denoising applied by increasing the value of α_{NM}, which can range between [0, 1]. Increasing the α_{NM} smooths out the image at the cost of some details in the image. During the training of the denoiser, the value of the noise map factor α_{NM} is set to 1.

In a trained state, the denoiser may use the re-noising factor to control the denoising processing based on a desired ratio between the input image and the denoised or output image (prior to conversion) from the CNN algorithm 600. The re-noising factor equation is as follows:

G′(y)=α_{RF}I+(1−α_{RF})G_{(y)}

A user can adjust the ratio between the input image and the denoised or output image by adjusting the value of the re-noising factor α_{RF}, which can range between [0, 1]. The re-noising factor is a multiplicative weight. Increasing the α_{RF} increases the contribution of input image and thus noise is reintroduced into the denoised or output image. That is, details may be restored. The value of α_{RF} can be adjusted based on confidence level in the CNN algorithm 600, desire to hide artifacts introduced by the CNN algorithm 600, recovery of lost details, or combinations thereof. The re-noising factor is not enabled or used during the training of the CNN algorithm 600.

Operationally with respect to FIGS. 4-7, a detected and captured image is processed via the image processing units 410. The processed image is processed by the denoiser 420. The processed image is in a non-linear color space such as YUV. The denoiser 420 is a CNN based denoiser which has weights trained using a linear color space loss calculation. Moreover, the CNN based denoiser is trained using a texture map parameter as described herein. Re-noising factor and noise map parameter can be selected and applied to the CNN based denoiser to fine tune output image. The denoiser 420 outputs in the non-linear color space.

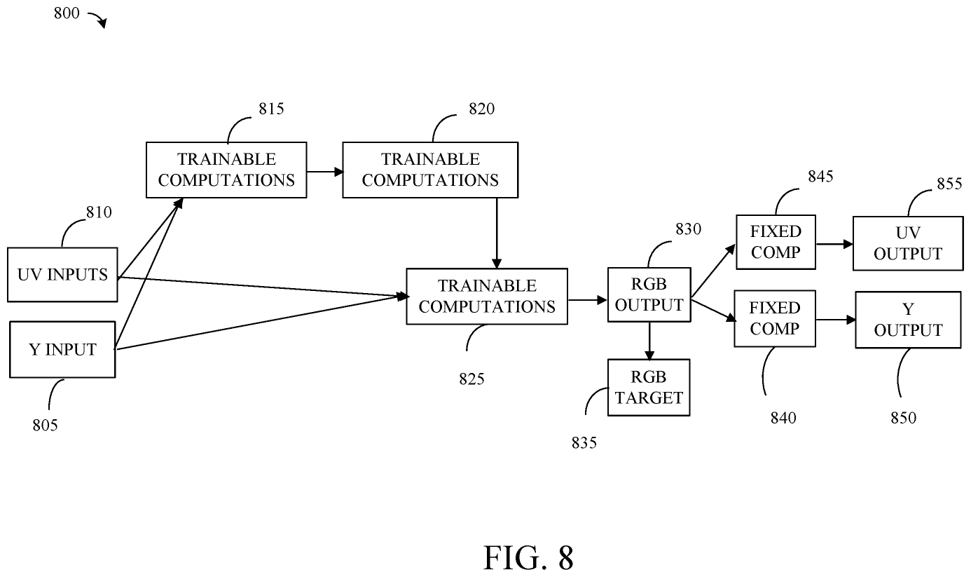

FIG. 8 is a block diagram of an example of a supervised training model, architecture, or configuration 800 for the CNN algorithm 600 of FIG. 6. Representation of the training configuration 800 is simplified to emphasize differences. For example, the CNN layers are represented by trainable computation blocks. The training configuration 800 is performed offline or in a training configuration, for example on a server or a cloud computing platform. Once the training is finished, the learned weights are saved and then loaded on the image capture device, for example at or during inference time.

The training configuration 800 may include provisions for the three inputs as described for the CNN algorithm 600 including input images, a noise map input having a noise map factor set to 1, and a disabled re-noising factor input. The input images to the training configuration 800 are a Y input channel 805 and UV input channels 810. The training configuration 800 includes a trainable computation block 815 connected to a trainable computation block 820, which in turn is connected to a trainable computation block 825. Inputs of the trainable computation block 815 and the trainable computation block 820 are connected to the Y input channel 805 and the UV input channels 810. The trainable computation block 825 may output an image in a linear format such as a RGB output 830. This is an intermediate output of having dimensions H×W×3, which is employed during the supervised training of the CNN algorithm 600. For example, this may be the output of the adder 675 in FIG. 6. The RGB output 830 can be compared against a RGB target 835, reference, or ground truth. That is, the training configuration 800 learns to map a noisy YUV input image into a denoised RGB output. Fixed computation blocks 840 and 845 can convert the RGB output 830 to a Y channel output 850 and UV channel outputs 855, respectively. The fixed computation blocks 840 and 845 are not learned during the training and are static.

A typical training loss computation for a CNN model may be defined as a L2 norm between a ground truth or clean image x and an output G(y) of a denoiser as follows:

L(x,y)=∥x−G(y)∥₂

As noted above, the CNN algorithm 600 employs a texture mapping parameter which is tuned using a texture map factor α_{TM} and is then set as part of the training process. The training loss computation then becomes as follows:

L(x,y)=∥x−G(y)*M∥₂+α_{TM}∥(x−G(y))*(1−M)∥₂

M is a texture map computed on the ground truth image and is a multiplicative per pixel weight. The texture map factor α_{TM} has a user selectable value between [0, 1]. Each selection of the texture map factor α_{TM} incurs a retraining of the CNN algorithm or model. If the texture map factor α_{TM} is set closer to 1, then more weight is provided to textures areas in the image. If the texture map factor α_{TM} is set closer to 0, then more weight is provided to flat areas in the image. In the latter case, this means image smoothness or less noise at the cost of texture details.

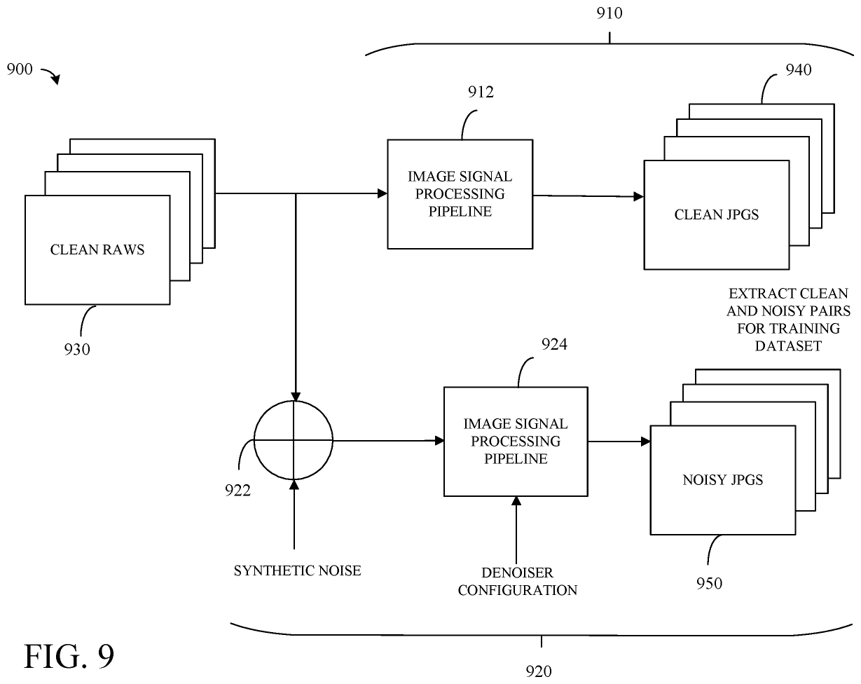

FIG. 9 is a block diagram of an example of a training database generation system 900 for the CNN system 600 of FIG. 6. The system 900 may include a ground truth or clean image path 910 and a noisy image path 920. The ground truth image path 910 may include an image signal processing pipeline 912. The noisy image path 920 may include a noise adder 922 connected to an image signal processing pipeline 924.

A set of clean raw images 930 are input to each of the ground truth image path 910 and the noisy image path 920. In the ground truth image path 910, the clean raw images 930 are processed through the image signal processing pipeline 912 to output clean images 940 in a format such as a Joint Photographic Experts Group (JPEG) format. In the noisy image path 920, synthetic noise is added to the clean raw images 930 to generate noisy raw images. For example, the synthetic noise can represent different ISOs or other image noise factors. The noisy raw images are processed through the image signal processing pipeline 924 including the denoiser to output noisy images such as noisy JPEGS 950. Clean and noisy JPEG pairs are extracted to generate a training dataset.

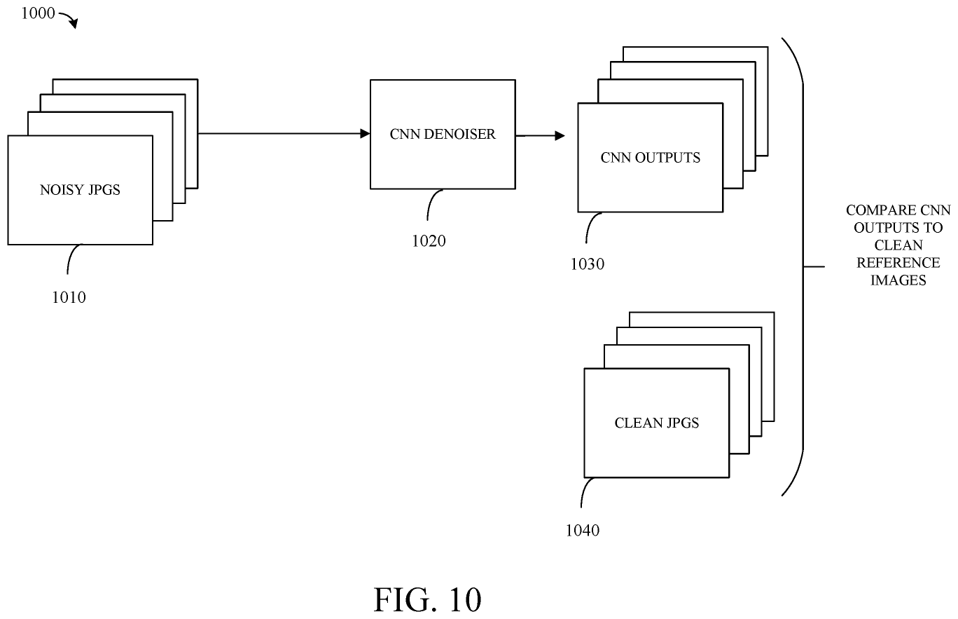

FIG. 10 is a block diagram of an example of training 1000 the CNN algorithm 600 of FIG. 6. Noisy JPEGS 1010 are input to a CNN denoiser 1020. The CNN denoiser 1020 may be in the training configuration 800 of FIG. 8. The CNN denoiser 1020 may process the noisy JPEGS 1010 and output CNN outputs 1030. The CNN outputs 1030 may be compared to clean JPEGS 1040 to compute a loss as described herein. An optimization algorithm, as are well-known in the art, may be used to train the CNN weights. In implementations, a trained denoiser may use a selected value for a texture map factor. Each texture map factor selection results in a differently trained denoiser.

FIG. 11 is a flowchart of an example technique 1100 for image denoising. The technique 1100 includes: receiving 1110 an image; denoising 1120 the image in non-linear space with linear space trained denoiser; and outputting 1130 a denoised image. For example, the technique 1100 may be implemented by the image capture device 100 shown in FIGS. 1A-1B, the image capture device 200 shown in FIGS. 2A-2D, the image capture device 300 shown in FIG. 3, the image signal processor 405 of FIG. 4, the denoiser 420 of FIG. 4, the CNN model 600 of FIG. 6, the training configuration 800 of FIG. 8, and the CNN denoiser 1020 of FIG. 10, as appropriate and applicable.

The technique 1100 includes receiving 1110 an image. An image capture device detects an image which is processed through certain elements of an image processing pipeline.

The technique 1100 includes denoising 1120 the image in non-linear space with linear space trained denoiser. After processing through the image processing pipeline, the image is input to a denoiser to denoise the image. The denoiser can be a trained CNN denoiser. The denoiser can include a tuned texture map parameter. That is, the texture map parameter is selected and set during the training of the denoiser. The texture map parameter is not used at inference time. The denoiser can include a tunable noise map parameter which accounts for light level conditions or ISO selections at image detection and capture. The tunable noise map parameter is set to a default value during training. The default value can be 1. The tunable noise map parameter is selectable during inference time. The denoiser can include a tunable re-noising factor which controls the amount of weight given to the input image and to the output image in generating a final output image. The tunable re-noising factor is disabled during training. The tunable re-noising factor is selectable during inference time. The input image to the denoiser is in a first color format and the denoiser is trained in a second color format.

The technique 1100 includes outputting 1130 a denoised image. The denoiser includes a color format converter to convert the image from the second color format to the first color format.

FIG. 12 is a flowchart of an example technique 1200 for image denoising training. The technique 1200 includes: inputting 1210 first color space noisy images; executing 1220 denoiser with defined weights on the first color space noisy images; comparing 1230 denoised second color space images with reference images; and adjusting 1240 the weights to minimize error between the denoised second color space images and the reference images. For example, the technique 1200 may be implemented by and the outputs of the technique 1200 may be used by the image capture device 100 shown in FIGS. 1A-1B, the image capture device 200 shown in FIGS. 2A-2D, the image capture device 300 shown in FIG. 3, the image signal processor 405 of FIG. 4, the denoiser 420 of FIG. 4, the CNN model 600 of FIG. 6, the training configuration 800 of FIG. 8, and the CNN denoiser 1020 of FIG. 10, as appropriate and applicable.

The technique 1200 includes inputting 1210 first color space noisy images. A training dataset is generated which includes clean image and noisy image pairs. The training dataset can be generated by processing clean raw images through an image processing pipeline to generate clean images and by processing noisy raw images through the image processing pipeline to generate noisy images, where the noisy raw images are generated by adding noise to the clean raw images. The added noise can be to simulate different image detection and capture environments including low light, bright light, and combinations thereof. The clean raw images can be in a first color space. The first color space can be YUV.

The technique 1200 includes executing 1220 denoiser with defined weights on the first color space noisy images. A denoiser can be a CNN denoiser with a defined set of weights. The denoiser can also include a texture map factor set to a selected value.

The technique 1200 includes comparing 1230 denoised second color space images with reference images. An intermediate image output of the CNN denoiser is compared to a reference image. The intermediate image output is in a second color space. The second color space can be RGB. A loss calculation can be performed as between the intermediate image output and the reference image.

The technique 1200 includes adjusting 1240 the weights to minimize error between the denoised second color space images and the reference images. An optimization algorithm can be used to minimize the error as determined by the loss calculation. The training process is an iterative process based on weight selection and loss optimization. In addition, the texture map parameter may be changed, where each texture map parameter value requires its own training run for the denoiser. The technique 1200 is performed offline or in a training configuration, for example on a server or a cloud computing platform. Once the training is finished, the learned weights are saved and then loaded on the image capture device, for example at or during inference time.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method for denoising, the method comprising:
receiving an image from an image sensor;
denoising the image, in a non-linear domain by a denoiser, by applying a noise map to the image to obtain a denoised image, wherein training losses for the denoiser are processed in a linear domain; and
storing, displaying, or transmitting an output image based on the denoised image.

2. The method of claim 1, wherein the denoising the image further comprises:
applying a re-noising factor to the image to obtain the denoised image.

3. The method of claim 1, wherein texture map processing is accounted for during denoiser training.

4. The method of claim 1, further comprising:
processing, in the non-linear domain by the denoiser in an offline configuration, a noisy image from a training dataset to obtain a training denoised image;
comparing, in a linear domain, the training denoised image with a reference image; and
optimizing the denoiser based on the comparison of the training denoised image with the reference image.

5. The method of claim 4, wherein the noise map is factored with a unity value.

6. The method of claim 4, further comprising:
determining a loss between the training denoised image and the reference image, wherein the loss accounts for a texture map.

7. The method of claim 4, further comprising:
setting a factor for a texture map which provides a greater weight to one of flat or texture in the noisy image; and
determining a texture map-based loss between the training denoised image and the reference image.

8. A method for denoising, the method comprising:
denoising an image, in a first color space by a denoiser, by applying a re-noising factor to the image to obtain a denoised image, wherein training losses for the denoiser are processed in a second color space; and
storing, displaying, or transmitting an output image based on the denoised image.

9. The method of claim 8, wherein the denoising the image further comprising:
applying a noise map to the image to obtain the denoised image.

10. The method of claim 8, wherein texture map weighting is accounted for during denoiser training.

11. The method of claim 8, further comprising:
processing, in the first color space by the denoiser in a training configuration, a noisy image from a training dataset;
comparing, in a second color space, a training denoised image with a reference image; and
optimizing the denoiser based on the comparison of the training denoised image with the reference image,
wherein the re-noising factor is disabled during denoiser training.

12. The method of claim 11, wherein a noise map applied during denoising is factored with a unity value during training.

13. The method of claim 11, further comprising:
determining a loss between the training denoised image and the reference image, wherein the loss accounts for a texture map weighting.

14. The method of claim 11, further comprising:
setting a factor for a texture map which provides a greater weight to one of flat or texture in the noisy image; and
determining a texture map-based loss between the training denoised image and the reference image.

15. The method of claim 11, wherein the first color space is YUV.

16. The method of claim 15, wherein the second color space is RGB.

17. An image capture device, comprising:
an image sensor configured to detect an image; and
an image processor configured to receive the image in a first color domain and comprising a denoiser configured to denoise the image to obtain a denoised image in the first color domain,
wherein weights and training losses for the denoiser are processed in a second color domain during an offline configuration and the weights are saved to the image capture device, and
wherein the image processor is configured to store, display, or transmit an output image based on the denoised image.

18. The image capture device of claim 17, wherein the denoiser is further configured to:
apply a re-noising factor to the image to obtain the denoised image.

19. The image capture device of claim 18, wherein the denoiser is further configured to:
apply a noise map to the image to obtain the denoised image.

20. The image capture device of claim 19, wherein the training losses account for a texture map weighting selection which emphasizes one of flat or texture in the image.
